(19) United States
(12) Patent Application Publication
(10) Pub. No.: US 2011/0229315 A1
(43) Pub. Date: Sep. 22, 2011

(54) HIGH EFFICIENCY ROTOR BLADES FOR A FLUID TURBINE

(76) Inventors: Walter M. Presz, JR., Wilbraham, MA (US); Michael J. Werle, West Hartford, CT (US)

(21) Appl. No.: 13/078,340

(22) Filed: Apr. 1, 2011

Related U.S. Application Data
(63) Continuation-in-part of application No. 12/054,050, filed on Mar. 24, 2008.
Application No. 12/054,050 is a continuation-in-part of application No. 12/749,341, filed on Mar. 29, 2010.
Application No. 12/749,341 is a continuation-in-part of application No. 12/054,050, filed on Mar. 24, 2008.
Application No. 12/749,341 is a continuation-in-part of application No. 12/425,358, filed on Apr. 16, 2009.
Application No. 12/425,358 is a continuation-in-part of application No. 12/053,695, filed on Mar. 24, 2008.
Application No. 12/749,341 is a continuation-in-part of application No. 12/629,714, filed on Dec. 2, 2009.
(60) Provisional application No. 61/332,722, filed on May 7, 2010.
(60) Provisional application No. 61/415,640, filed on Nov. 19, 2010.
(60) Provisional application No. 60/919,588, filed on Mar. 23, 2007.
(60) Provisional application No. 60/919,588, filed on Mar. 23, 2007.
(60) Provisional application No. 60/919,588, filed on Mar. 23, 2007.
(60) Provisional application No. 61/124,397, filed on Apr. 16, 2008.
(60) Provisional application No. 61/119,078, filed on Dec. 2, 2008.

(51) Int. Cl. F03D 1/04; F01D 9/04

(52) U.S. Cl. 415/191

(57) ABSTRACT

A shrouded fluid turbine includes an impeller surrounded by a turbine shroud. The turbine shroud has a plurality of mixing lobes on a trailing edge, resulting in the trailing edge having a circular crenellated shape. An ejector shroud is located downstream of the turbine shroud, an inlet end of the ejector shroud surrounding the mixing lobes of the turbine shroud. The impeller is a rotor/stator assembly. In particular, the rotor comprises a rotor hub formed from a cylindrical sidewall and has seven rotor blades extending radially from the hub. It has been found that seven rotor blades optimizes the total-to-total efficiency of the shrouded fluid turbine.

### BACKGROUND

This application claims priority from U.S. Provisional Patent Application Ser. No. 61/332,722, filed May 7, 2010, and U.S. Provisional Patent Application Ser. No. 61/415,640, filed Nov. 19, 2010. This application is also a continuation-in-part from U.S. patent application Ser. No. 12/054,050, filed Mar. 24, 2008, which claimed priority from U.S. Provisional Patent Application Ser. No. 60/919,588, filed Mar. 23, 2007. This application is also a continuation-in-part from U.S. patent application Ser. No. 12/749,341, filed Mar. 29, 2010, which was a continuation-in-part of U.S. patent application Ser. No. 12/054,050, filed Mar. 24, 2008, which claimed priority to U.S. Provisional Patent Application Ser. No. 60/919,588, filed Mar. 23, 2007. U.S. patent application Ser. No. 12/749,341 is also a continuation-in-part of U.S. patent application Ser. No. 12/425,358, filed Apr. 16, 2009, which is a continuation-in-part of U.S. patent application Ser. No. 12/053,695, filed Mar. 24, 2008, which claimed priority to U.S. Provisional Patent Application Ser. No. 60/919,588, filed Mar. 23, 2007. U.S. patent application Ser. No. 12/425,358 also claimed priority to U.S. Provisional Patent Application Ser. No. 61/124,397, filed Apr. 16, 2008. U.S. patent application Ser. No. 12/749,341 is also a continuation-in-part of U.S. patent application Ser. No. 12/629,714, filed Dec. 2, 2009, which claimed priority to U.S. Provisional Patent Application Ser. No. 61/119,078, filed Dec. 2, 2008. Applicants hereby fully incorporate the disclosures of these applications by reference in their entirety.

The present disclosure relates to shrouded fluid turbines having high efficiency rotor blades.

Conventional horizontal axis wind turbines (HAWTs) used for power generation have two to five open blades arranged like a propeller, the blades being mounted to a horizontal shaft attached to a gear box which drives a power generator. The blades generally rotate at a rotational speed of about 10 to 22 rpm, with tip speeds reaching over 200 mph. HAWTs will not exceed the Betz limit of 59.3% efficiency in capturing the potential energy of the wind passing through it. It would be desirable to increase the efficiency of a fluid turbine by collecting additional energy from the fluid.

### BRIEF DESCRIPTION

Disclosed herein are rotors that can be used to increase the efficiency of a shrouded horizontal axis fluid turbine, and shrouded fluid turbines incorporating such rotors. The rotor or impeller incorporates seven rotor blades with an aerodynamic blade design that allows more kinetic energy from the fluid to be converted into electrical energy, resulting in higher efficiency.

Disclosed in embodiments is a shrouded fluid turbine, comprising an impeller and a turbine shroud. The impeller comprises a stator and a rotor. The rotor comprises seven rotor blades and a rotor hub. The rotor hub has a sidewall and a central passageway. Each rotor blade extends radially from the rotor hub and has a root engaging the sidewall of the rotor hub, a tip, and a length extending from the root to the tip. The turbine shroud surrounds the impeller, the turbine shroud having a plurality of mixing lobes formed on a trailing edge thereof. The fluid turbine has a total-to-total efficiency of at least 90%.

Each rotor blade may have a constant pitch angle along the length. Such a fluid turbine may have a total-to-total efficiency of at least 91%.

The blades may have an aspect ratio of from 2 to 30, including from 10 to 25.

In some embodiments, each rotor blade has a variable pitch angle along the length determined according to the formula α=Kr, where α is the pitch angle in degrees relative to a longitudinal axis of the rotor hub, K is a constant having a value from 0.1 to 90, and r is the distance from the root. Such a fluid turbine may have a total-to-total efficiency of at least 94%.

The root of each rotor blade may have a pitch angle of from greater than zero to less than 90 degrees relative to a central longitudinal axis of the rotor hub. Alternatively, each blade root may have a zero pitch angle relative to a central longitudinal axis of the rotor hub.

The fluid turbine may further comprise an ejector shroud downstream of the turbine shroud, a rear end of the turbine shroud extending into an inlet end of the ejector shroud.

The fluid turbine may also further comprise a nacelle body rotationally engaged to the rotor, wherein the nacelle body comprises an inlet, an outlet, and a central channel between the inlet and the outlet. The central channel passes through the central passageway of the turbine rotor hub.

The turbine shroud may have an airfoil cross-section configured to provide a rotor inlet velocity within the turbine shroud of at least 2.5 times a free stream fluid velocity.

Also disclosed is a shrouded horizontal axis fluid turbine, comprising an impeller and a turbine shroud. The impeller comprises a stator and a rotor. The rotor comprises seven rotor blades and a rotor hub. The rotor hub has a sidewall and a central passageway. The turbine shroud surrounds the impeller. The turbine shroud has a plurality of mixing lobes formed on a trailing edge thereof. Each rotor blade extends radially from the rotor hub and has a root engaging the sidewall of the rotor hub, a tip, a length extending from the root to the tip, the blade having a constant pitch angle along the length of the blade. The fluid turbine has a total-to-total efficiency of at least 91%.

Also disclosed is a shrouded horizontal axis fluid turbine, comprising an impeller and a turbine shroud. The impeller comprises a stator and a rotor. The rotor comprises seven rotor blades and a rotor hub. The rotor hub has a sidewall and a central passageway. The turbine shroud surrounds the impeller. The turbine shroud has a plurality of mixing lobes formed on a trailing edge thereof. Each rotor blade extends radially from the rotor hub and has a root engaging the sidewall of the rotor hub, a tip, a length extending from the root to the tip, the blade having a varying pitch angle along the length of the blade. The fluid turbine has a total-to-total efficiency of at least 94%.

These and other non-limiting features or characteristics of the present disclosure will be further described below.

### BRIEF DESCRIPTION OF THE DRAWINGS

The following is a brief description of the drawings, which are presented for the purposes of illustrating the disclosure set forth herein and not for the purposes of limiting the same.

FIG. 1 is a front view of a turbine rotor having a constant pitch angle along the length of each rotor blade and a non-zero pitch angle at the root of each rotor blade.

FIG. 2 is a top view of the turbine rotor of FIG. 1.

FIG. 3 is a top view of the turbine rotor of FIG. 1 showing only one rotor blade.

FIG. 3A is a cross-sectional view taken along the blade axis at the root.

FIG. 3B is a cross-sectional view taken along the blade axis at the center.

FIG. 3C is a cross-sectional view taken along the blade axis at the tip.

FIG. 4 is a front view of a turbine rotor with blades having a varying pitch angle along the length of each rotor blade (i.e. a twisted cross-section) and a zero pitch angle at the root of each rotor blade.

FIG. 5 is a top view of the turbine rotor of FIG. 4.

FIG. 6 is a top view of the turbine rotor of FIG. 4 showing only one rotor blade.

FIG. 6A is a cross-sectional view taken along the blade axis at the root.

FIG. 6B is a cross-sectional view taken along the blade axis at the center.

FIG. 6C is a cross-sectional view taken along the blade axis at the tip.

FIG. 7 is a front left perspective view of an exemplary embodiment of a shrouded fluid turbine of the present disclosure.

FIG. 8 is a rear right perspective view of the shrouded fluid turbine of FIG. 7.

FIG. 9 is a cross-sectional view of the shrouded fluid turbine of FIG. 7.

FIG. 10 is a smaller view of FIG. 9.

FIG. 10A and FIG. 10B are magnified views of the mixing lobes of the fluid turbine of FIG. 7.

FIG. 11 is a rear view of the shrouded fluid turbine of FIG. 7. The blades of the impeller are removed from this figure so that other aspects of the fluid turbine can be more clearly seen and explained.

### DETAILED DESCRIPTION

A more complete understanding of the components, processes, and apparatuses disclosed herein can be obtained by reference to the accompanying figures. These figures are intended to demonstrate the present disclosure and are not intended to show relative sizes and dimensions or to limit the scope of the exemplary embodiments.

Although specific terms are used in the following description, these terms are intended to refer only to particular structures in the drawings and are not intended to limit the scope of the present disclosure. It is to be understood that like numeric designations refer to components of like function.

The term “about” when used with a quantity includes the stated value and also has the meaning dictated by the context. For example, it includes at least the degree of error associated with the measurement of the particular quantity. When used in the context of a range, the term “about” should also be considered as disclosing the range defined by the absolute values of the two endpoints. For example, the range “from about 2 to about 4” also discloses the range “from 2 to 4.”

A Mixer-Ejector Power System (MEPS) provides an improved means of generating power from wind currents. A primary shroud contains an impeller which extracts power from a primary wind stream. A mixer-ejector pump is included that ingests flow from the primary wind stream and secondary flow, and promotes turbulent mixing. This enhances the power system by increasing the amount of air flow through the system, reducing back pressure on turbine blades, and reducing noise propagating from the system.

The term “impeller” is used herein to refer to any assembly in which blades are attached to a shaft and able to rotate, allowing for the generation of power or energy from fluid rotating the blades. Exemplary impellers include a propeller or a rotor/stator assembly. Any type of impeller may be enclosed within the turbine shroud in the fluid turbine of the present disclosure.

The leading edge of a turbine shroud may be considered the front of the fluid turbine, and the trailing edge of an ejector shroud may be considered the rear of the fluid turbine. A first component of the fluid turbine located closer to the front of the turbine may be considered “upstream” of a second component located closer to the rear of the turbine. Put another way, the second component is “downstream” of the first component.

The present disclosure relates to the finding that using a rotor/stator assembly as an impeller in a shrouded fluid turbine achieves high efficiency when the rotor has seven rotor blades. The shrouded fluid turbine itself includes a turbine shroud surrounding the impeller and an ejector shroud downstream of the turbine shroud. The turbine shroud includes a plurality of mixing lobes on a trailing edge, such that the trailing edge has a circular crenellated shape. The mixing lobes extend into an inlet end of the ejector shroud. The shrouded fluid turbine with this rotor has an overall efficiency calculated to be at least 90%, as determined by computational fluid dynamics (CFD). The fluid turbine may be, for example, a wind turbine or a fluid turbine.

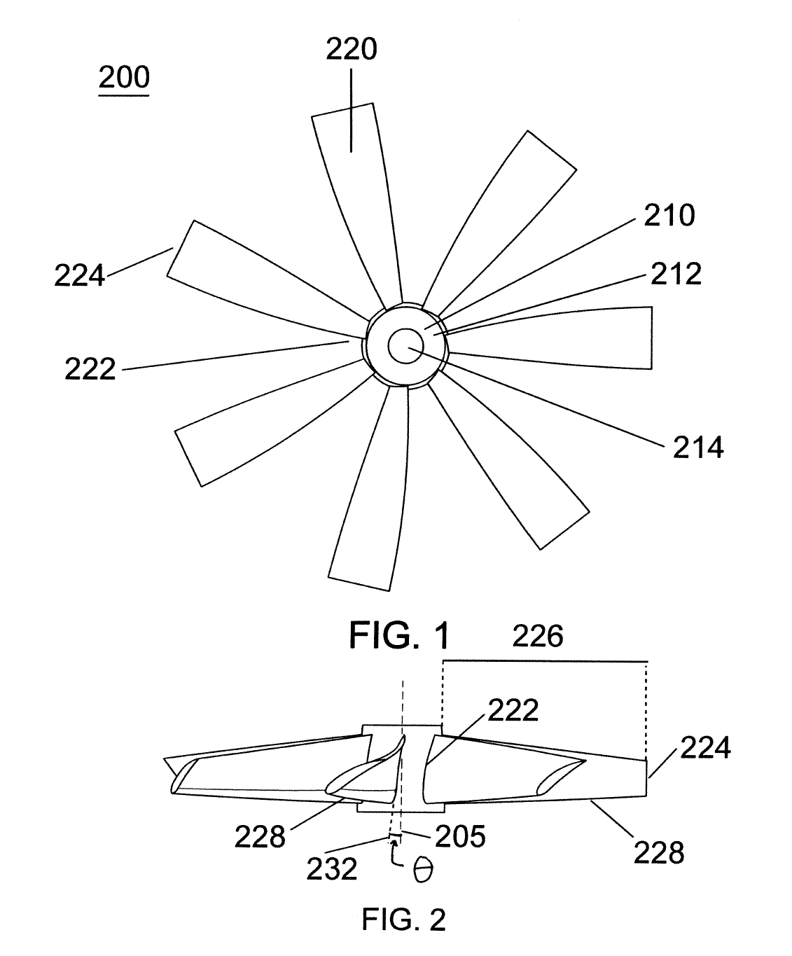

FIGS. 1-3 are different views of a first exemplary rotor of the present disclosure, having seven rotor blades. The rotor 200 comprises a rotor hub 210 and seven rotor blades 220. The rotor hub 210 is formed from a cylindrical sidewall 212 surrounding and defining a central passageway 214. Each rotor blade 220 has a root 222 and a tip 224 at opposite ends of the blade, with a blade length 226 extending from the root to the tip. The blade itself generally has an airfoil shape, as will be further described herein. The root 222 of each blade engages the sidewall 212 of the rotor hub. As seen in FIG. 1, the blades are evenly spaced about the sidewall.

Referring now to FIG. 2, the rotor has a central longitudinal axis 205, around which the rotor 200 will rotate. The root 222 of each blade has a pitch angle θ where the blade 220 engages the sidewall 212. This root pitch angle is measured between the central longitudinal axis 205 and the chord 232 of the blade 220 at the root 222. This exemplary rotor has a non-zero pitch angle θ, which is measured towards the leading edge 228 of the rotor, and as a result θ cannot exceed 90 degrees. In embodiments, θ is from greater than zero to less than 90 degrees. A non-zero pitch angle decreases the drag due to lift acting on the rotor blades, as well as the fluid turbine as a whole. In other embodiments, θ is from 5 to 30 degrees, or from 15 to 45 degrees, or from 30 to 70 degrees.

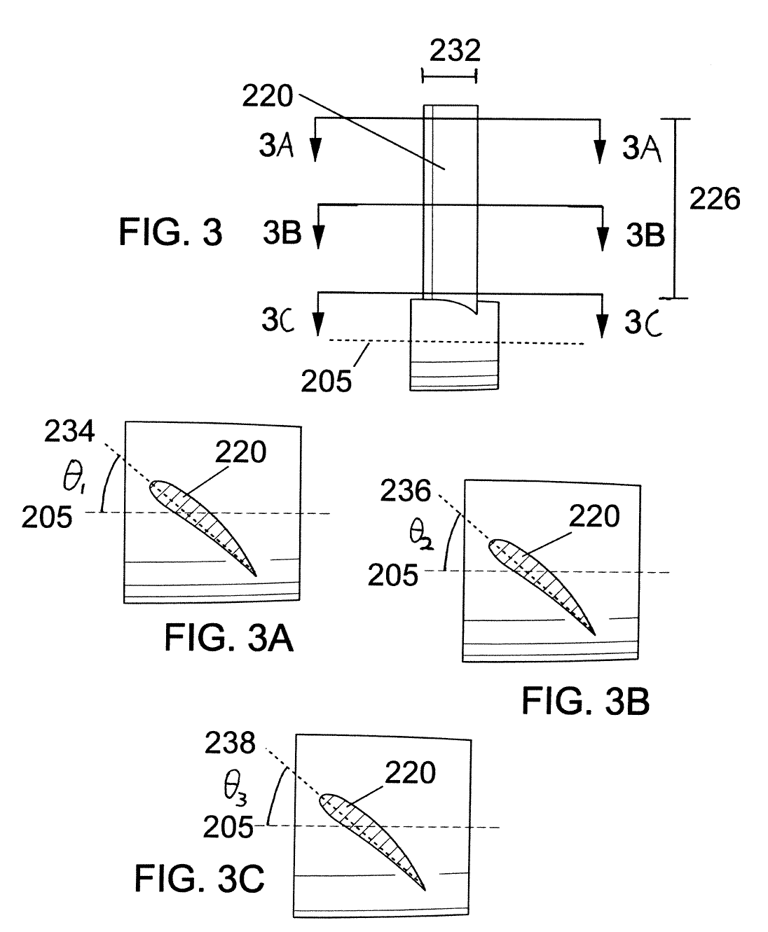

Referring now to FIG. 3, each rotor blade 220 has a constant chord 232 and cross-section along the length 226 of the blade. Put another way, the blade 220 has a constant pitch angle θ along the length 226 of the blade. This is illustrated by the cross-sectional views shown here for the root, center, and tip of the blade. In FIG. 3A, which shows the cross-section at the root 222, the chord 234 and the central longitudinal axis 205 form an angle θ1. In FIG. 3B, which shows the cross-section at the center, the chord 236 and the central longitudinal axis 205 form an angle θ2. In FIG. 3C, which shows the cross-section at the tip, the chord 238 and the central longitudinal axis 205 form an angle θ3. The three chords 234, 236, 238 have the same breadth. Angles θ1, θ2, and θ3 are equal. This particular embodiment of a rotor blade 220 results in a shrouded fluid turbine having a total-to-total efficiency of at least 91%, as determined by CFD.

The aspect ratio is the ratio of the length 226 of the blade to the chord 232 (i.e. breadth) of the blade. In the embodiment of FIG. 1, the chord 232 is constant along the length 226 of the rotor blade. However, if the chord varies along the length of the rotor blade, the aspect ratio is determined as the ratio of the length squared divided by the area of the rotor blade when viewed from the top (i.e. the planform of the blade), as in FIG. 2. In embodiments, the rotor blade has an aspect ratio of from 2 to 30, including from 10 to 25.

Other embodiments may have a cross-section that varies along the length of the blade while maintaining a constant pitch angle.

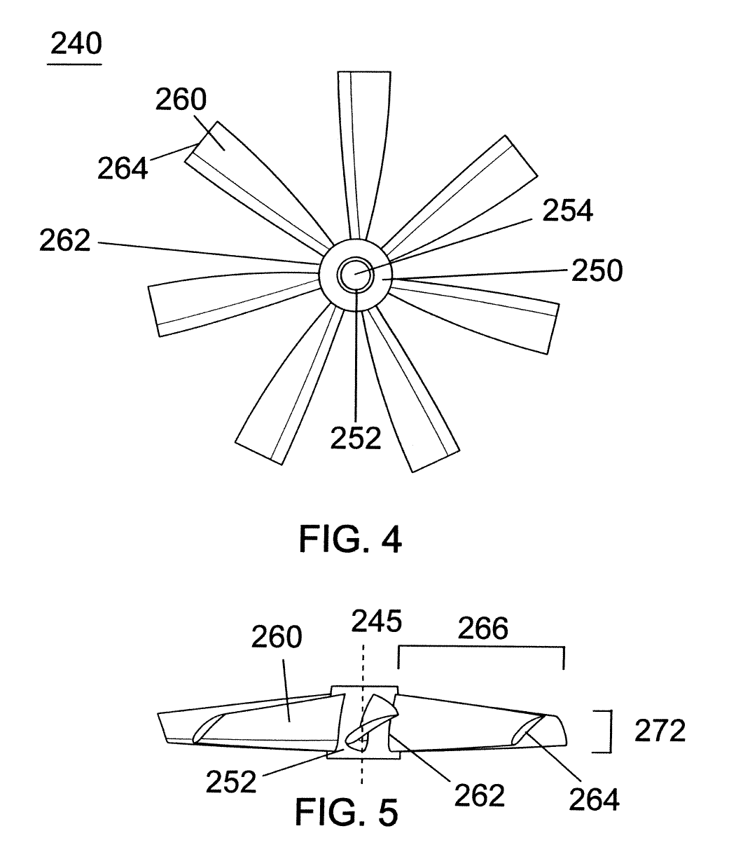

FIGS. 4-6 depict another exemplary version of a turbine rotor 240 having seven rotor blades. Again, the turbine rotor 240 comprises a rotor hub 250 and seven rotor blades 260. The rotor hub 250 is a cylindrical sidewall 252 having a central passageway 254. Each rotor blade 260 has a root 262 and a tip 264 at opposite ends of the blade, with a blade length 266 extending from the root to the tip. The root 262 of each blade 260 engages the sidewall 252 of the rotor hub 250.

As seen in FIG. 5, the rotor hub has a central longitudinal axis 245. The root of each blade has a pitch angle of zero.

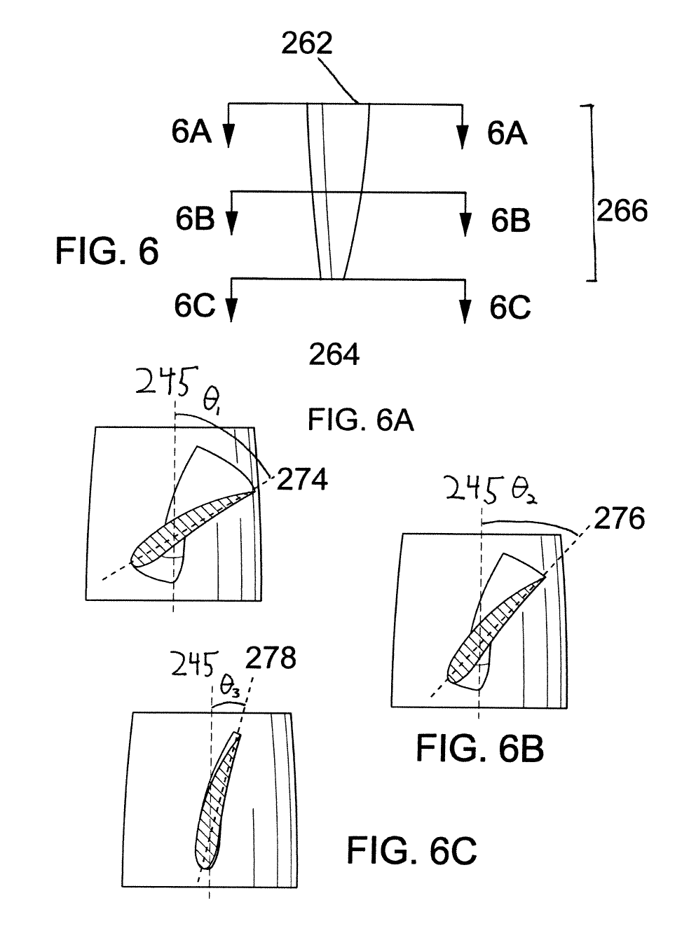

As seen in FIG. 6, the rotor blades 260 are twisted. While the cross-section and the chord 272 remain constant along the length 266 of the rotor blade, the pitch angle θ changes. Put another way, each rotor blade 260 has a cross-section that is rotated along the length 266 of the blade. In other words, the pitch angle θ increases from the root 262 to the tip 264 of the blade.

In embodiments, the pitch angle ranges from greater than 0 to less than 90 degrees. The pitch angle may change as a function of the radial position along the blade according to the formula α=Kr, where α is the pitch angle in degrees relative to a longitudinal axis of the rotor hub, K is a constant having a value from 0.1 to 90, and r is the distance from the blade root 262 along the blade, wherein r is from 0 to 1 (r=0 at the root, r=1 at the tip). A shrouded fluid turbine with a twisted rotor configured as shown here has a total-to-total efficiency calculated by CFD to be at least 94%. This turbine rotor is able to operate at high fluid speeds without a substantial loss in performance and without the aid of dynamic blade pitch controls.

In FIG. 6A, which shows the cross-section at the root, the chord 274 and the central longitudinal axis 245 form an angle θ1. Here, θ1 is zero. In FIG. 6B, which shows the cross-section at the center, the chord 276 and the central longitudinal axis 245 form an angle θ2. In FIG. 6C, which shows the cross-section at the tip, the chord 278 and the central longitudinal axis 245 form an angle θ3. The three chords 274, 276, 278 have the same breadth. However, angle θ1<θ2. Also, angle θ2<θ3.

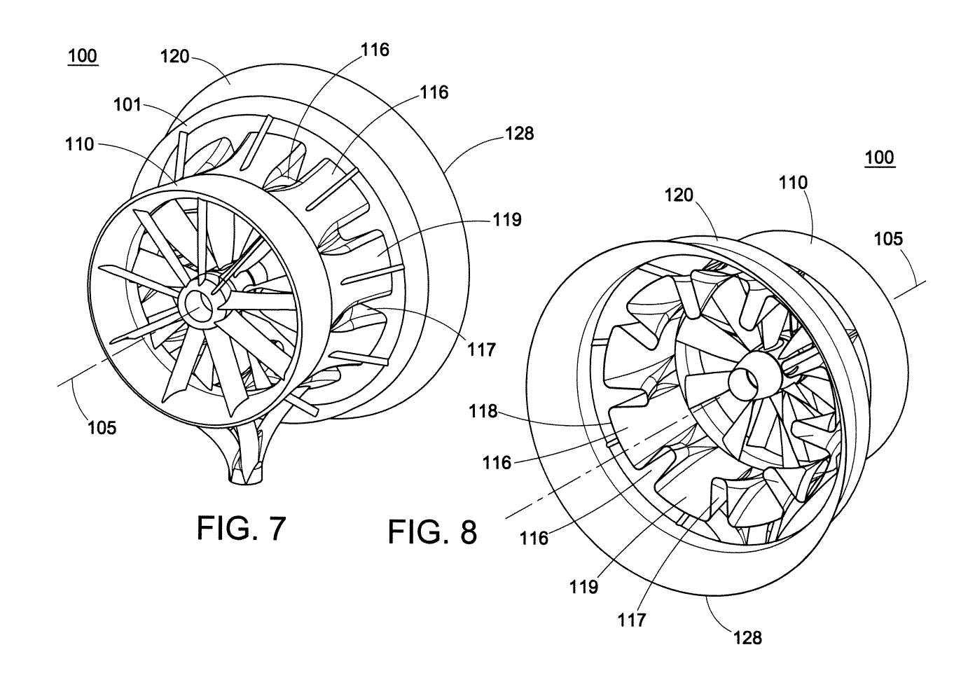

A shrouded fluid turbine incorporating the rotors of the present disclosure is shown in FIGS. 7-11. The shrouded fluid turbine 100 comprises an aerodynamically contoured turbine shroud 110, an aerodynamically contoured nacelle body 150, an impeller 140, and an aerodynamically contoured ejector shroud 120. The turbine shroud 110 includes a front end 112 and a rear end 114. The ejector shroud 120 includes an inlet end 122 and an exhaust end 124. Support members 106 connect the turbine shroud 110 to the ejector shroud 120.

The impeller 140 surrounds the nacelle body 150. Here, the impeller is a rotor/stator assembly comprising a stator 142 having stator vanes 144 and a rotor 146 having rotor blades 148. The rotor 146 is downstream and “in-line” with the stator vanes 144. Put another way, the leading edges of the rotor blades are substantially aligned with the trailing edges of the stator vanes. The rotor blades are held together by the hub, and the rotor 146 is rotationally engaged to the nacelle body 150. The nacelle body 150 is connected to the turbine shroud 110 through the stator 142, or by other means. The nacelle comprises an inlet 154, an outlet 156, and a central channel 152 between the inlet 154 and the outlet 156 that extends through the nacelle body 150.

The turbine shroud has the cross-sectional shape of an airfoil with the suction side (i.e. low pressure side) on the interior of the shroud. The turbine shroud is configured to provide a rotor inlet velocity within the turbine shroud of at least 2.5 times the free stream fluid velocity to which the fluid turbine is exposed. The rear end 114 of the turbine shroud also has mixing lobes 116. The mixing lobes extend downstream beyond the rotor blades. Put another way, the trailing edge 118 of the turbine shroud is formed from a plurality of mixing lobes. The rear or downstream end of the turbine shroud is shaped to form two different sets of mixing lobes 116. High energy mixing lobes 117 extend inwardly towards the central axis 105 of the mixer shroud. Low energy mixing lobes 119 extend outwardly away from the central axis 105. These mixing lobes are more easily seen in FIG. 8.

A mixer-ejector pump (indicated by reference numeral 101) comprises an ejector shroud 120 surrounding the ring of mixing lobes 116 on the turbine shroud 110. The mixing lobes 116 extend downstream and into an inlet end 122 of the ejector shroud 120. Put another way, the rear end 114 of the turbine shroud 110 extends into the inlet end 122 of the ejector shroud 120. This mixer/ejector pump provides the means for consistently exceeding the Betz limit for operational efficiency of the fluid turbine.

The turbine shroud's entrance area and exit area will be equal to or greater than that of the annulus occupied by the impeller. The internal flow path cross-sectional area formed by the annulus between the nacelle body and the interior surface of the turbine shroud is aerodynamically shaped to have a minimum cross-sectional area at the plane of the turbine and to otherwise vary smoothly from their respective entrance planes to their exit planes. The ejector shroud entrance area is greater than the exit plane area of the turbine shroud.

Several optional features may be included in the shrouded fluid turbine. A power take-off, in the form of a wheel-like structure, can be mechanically linked at an outer rim of the impeller to a power generator. Sound absorbing material can be affixed to the inner surface of the shrouds, to absorb and prevent propagation of the relatively high frequency sound waves produced by the turbine. The fluid turbine can also contain blade containment structures for added safety. The shrouds will have an aerodynamic contour in order to enhance the amount of flow into and through the system. The inlet and outlet areas of the shrouds may be non-circular in cross section such that shroud installation is easily accommodated by aligning the two shrouds. A swivel joint may be included on a lower outer surface of the turbine for mounting on a vertical stand/pylon, allowing the turbine to be turned into the fluid in order to maximize power extraction. Vertical aerodynamic stabilizer vanes may be mounted on the exterior of the shrouds to assist in keeping the turbine pointed into the fluid.

The area ratio of the ejector pump, as defined by the ejector shroud 120 exit area over the turbine shroud 110 exit area, will be in the range of 1.5-3.0. The number of mixing lobes can be between 6 and 28. The height-to-width ratio of the lobe channels will be between 0.5 and 4.5. The mixing lobe penetration will be between 50% and 80%. The nacelle body 150 plug trailing edge angles will be thirty degrees or less. The length to diameter (L/D) of the overall fluid turbine will be between 0.5 and 1.25.

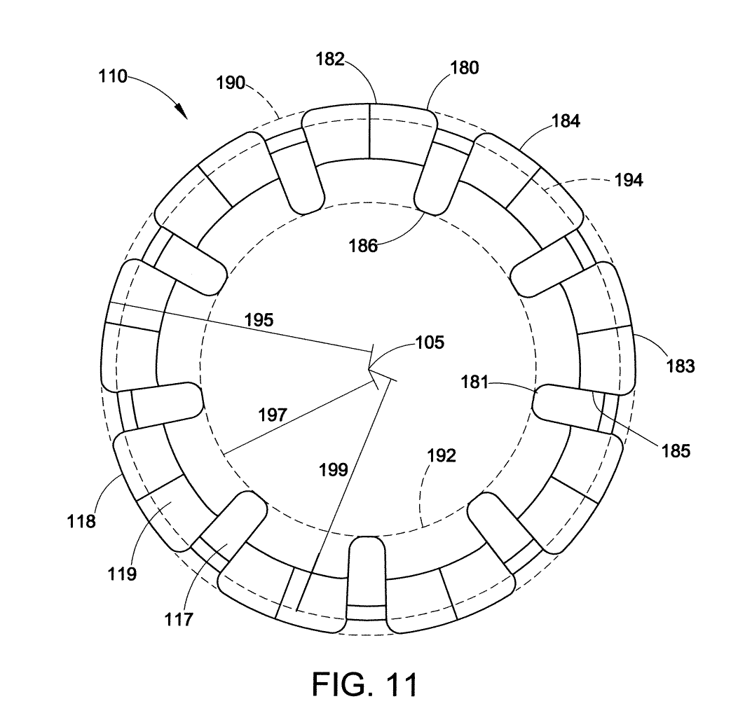

Referring now to FIG. 11, the turbine shroud 110 has a set of nine high energy mixing lobes 117 that extend inwards toward the central axis 105 of the turbine. The turbine shroud also has a set of nine low energy mixing lobes 119 that extend outwards away from the central axis. The high energy mixing lobes alternate with the low energy mixing lobes around the trailing edge 118 of the turbine shroud. The impeller 140, turbine shroud 110, and ejector shroud 120 are coaxial with each other, i.e. they share a common central axis 105.

The trailing edge 118 of the turbine shroud 110 has a circular crenellated shape. The trailing edge can be described as including several inner circumferentially spaced arcuate portions 181 which each have the same radius of curvature. Those inner arcuate portions 181 are evenly spaced apart from each other. Between portions are several outer arcuate portions 183, which each have the same radius of curvature. The radius of curvature for the inner arcuate portions 181 is different from the radius of curvature for the outer arcuate portions 183, but the inner arcuate portions and outer arcuate portions have the same center (i.e. along the central axis). The inner arcuate portions 181 and the outer arcuate portions 183 are then connected to each other by radially extending portions 185. This results in a circular crenellated shape. The term “crenellated” as used herein does not require the inner arcuate portions, outer arcuate portions, and radially extending portions to be straight lines, but instead refers to the general up-and-down or in-and-out shape of the trailing edge. This crenellated structure forms two sets of mixing lobes, high energy mixing lobes 117 and low energy mixing lobes 119.

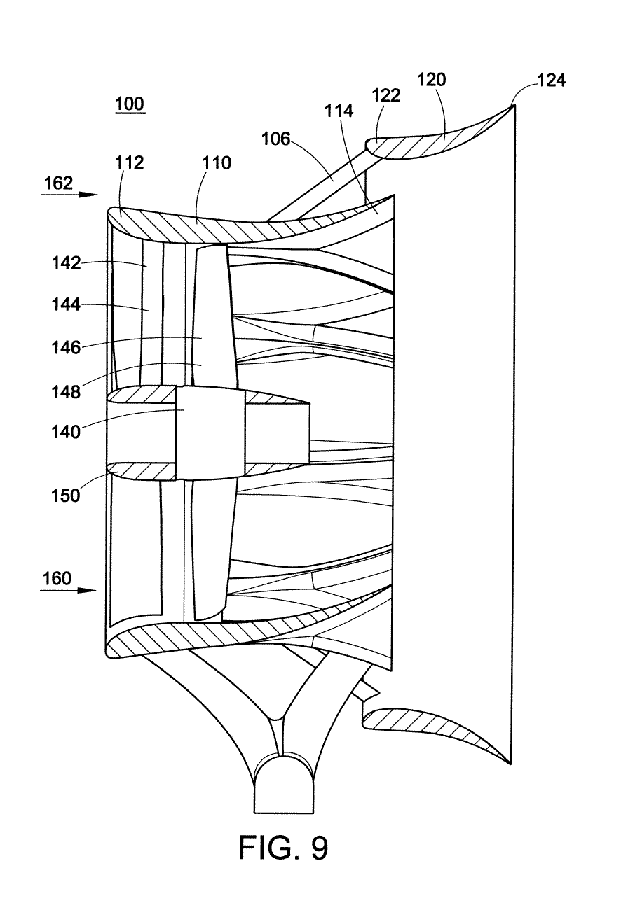

Referring now to FIG. 9, free stream fluid (indicated generally by arrow 160, and which may be, for example, wind or water) passing through the stator 142 has its energy extracted by the rotor 146. High energy fluid indicated by arrow 162 bypasses the turbine shroud 110 and stator 142, flows over the exterior of the turbine shroud 110, and is directed inwardly by the high energy mixing lobes 117. The low energy mixing lobes 119 cause the low energy fluid exiting downstream from the rotor 146 to be mixed with the high energy fluid 162.

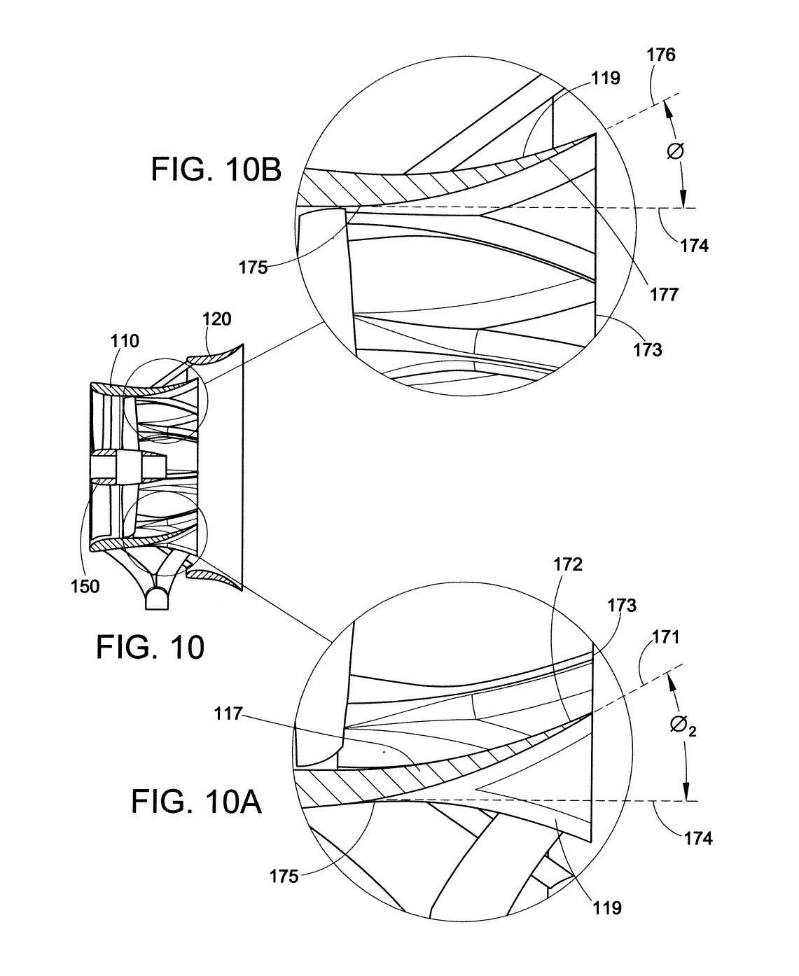

Referring now to FIG. 10A, a tangent line 171 is drawn along the interior trailing edge indicated generally at 172 of the high energy mixing lobe 117. A rear plane 173 of the turbine shroud 110 is present. A line 174 is formed normal to the rear plane 173 and tangent to the point 175 where a low energy mixing lobe 119 and a high energy mixing lobe 117 meet. An angle Φ₂ is formed by the intersection of tangent line 171 and line 174. This angle Φ₂ is between 5 and 65 degrees. Put another way, a high energy mixing lobe 117 forms an angle Φ₂ between 5 and 65 degrees relative to a longitudinal axis of the turbine shroud 110. In particular embodiments, the angle Φ₂ is from about 35° to about 50°.

In FIG. 10B, a tangent line 176 is drawn along the interior trailing edge indicated generally at 177 of the low energy mixing lobe 119. An angle Φ is formed by the intersection of tangent line 176 and line 174. This angle Φ is between 5 and 65 degrees. Put another way, a low energy mixing lobe 119 forms an angle Φ between 5 and 65 degrees relative to a longitudinal axis of the turbine shroud 110. In particular embodiments, the angle Φ is from about 35° to about 50°.

Mixing lobes are present on the turbine shroud. As shown in FIG. 2, the ejector shroud 120 has a ring airfoil shape and does not have mixing lobes. If desired, though, mixing lobes may also be formed on a trailing edge 128 of the ejector shroud.

FIG. 11 is a rear view that illustrates some additional aspects of the fluid turbine shroud and the shroud segments when mixing lobes are present. Referring to fluid turbine shroud segment 180, the first outer edge 182, the second outer edge 184, and the inner edge 186 are visible. The first outer edge 182 and the second outer edge 184 are located in an outer plane, which is indicated here with reference numeral 190. The inner edge 186 is located in an inner plane indicated here with reference numeral 192. As seen from this perspective, the outer plane 190 and inner plane 192 are generally cylindrical, with their axis being the central axis 105. The outer plane 190 and inner plane 192 are also coaxial.

In addition, the first outer edge 182 and the second outer edge 184 of the shroud segment 180 can be considered as having a common outer radius of curvature 195. The term “common” is used here to mean that the first outer edge and the second outer edge have the same radius of curvature. Similarly, the inner edge 186 has an inner radius of curvature 197. The front edge (not visible) of the shroud segment 180, indicated here as dotted circle 194, has a front radius of curvature 199. The outer radius of curvature 195 of the shroud segment is greater than the inner radius of curvature 197. The front radius of curvature 199 of the shroud segment 180 can be greater than, substantially equal to, or less than the outer radius of curvature 195.

In specific embodiments, the outer radius of curvature 195 of the shroud segment is greater than the inner radius of curvature 197, and the front radius of curvature 199 of the shroud segment 180 is also less than the outer radius of curvature 195.

The present disclosure has been described with reference to the exemplary embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A shrouded fluid turbine, comprising:
an impeller comprising a stator and a rotor, the rotor comprising seven rotor blades and a rotor hub, the rotor hub having a sidewall and a central passageway, each rotor blade extending radially from the rotor hub and having a root engaging the sidewall of the rotor hub, a tip, and a length extending from the root to the tip; and
a turbine shroud surrounding the impeller, the turbine shroud having a plurality of mixing lobes formed on a trailing edge thereof;
wherein the fluid turbine has a total-to-total efficiency of at least 90%.

2. The fluid turbine of claim 1, wherein each rotor blade has a constant pitch angle along the length.

3. The fluid turbine of claim 2, wherein the fluid turbine has a total-to-total efficiency of at least 91%.

4. The fluid turbine of claim 1, wherein the blades have an aspect ratio of from 2 to 30.

5. The fluid turbine of claim 1, wherein each rotor blade has a variable pitch angle along the length determined according to the formula α=Kr, where α is the pitch angle in degrees relative to a longitudinal axis of the rotor hub, K is a constant having a value from 0.1 to 90, and r is the distance from the root.

6. The fluid turbine of claim 5, wherein the fluid turbine has a total-to-total efficiency of at least 94%.

7. The fluid turbine of claim 1, wherein the root of each rotor blade has a pitch angle of from greater than zero to less than 90 degrees relative to a central longitudinal axis of the rotor hub.

8. The fluid turbine of claim 1, wherein each blade root has a zero pitch angle relative to a central longitudinal axis of the rotor hub.

9. The fluid turbine of claim 1, further comprising an ejector shroud downstream of the turbine shroud, a rear end of the turbine shroud extending into an inlet end of the ejector shroud.

10. The fluid turbine of claim 1, further comprising a nacelle body rotationally engaged to the rotor, wherein the nacelle body comprises an inlet, an outlet, and a central channel between the inlet and the outlet, wherein the central channel passes through the central passageway of the turbine rotor hub.

11. The fluid turbine of claim 1, wherein the turbine shroud has an airfoil cross-section configured to provide a rotor inlet velocity within the turbine shroud of at least 2.5 times a free stream fluid velocity.

12. A shrouded horizontal axis fluid turbine, comprising:
an impeller comprising a stator and a rotor, the rotor comprising seven rotor blades and a rotor hub, the rotor hub having a sidewall and a central passageway; and
a turbine shroud surrounding the impeller, the turbine shroud having a plurality of mixing lobes formed on a trailing edge thereof;
wherein each rotor blade extends radially from the rotor hub and has a root engaging the sidewall of the rotor hub, a tip, a length extending from the root to the tip, the blade having a constant pitch angle along the length of the blade; and
wherein the fluid turbine has a total-to-total efficiency of at least 91%.

13. The fluid turbine of claim 12, wherein the roots of the rotor blades have a pitch angle of from greater than zero to less than 90 degrees relative to a central longitudinal axis of the rotor hub.

14. The fluid turbine of claim 12, further comprising an ejector shroud downstream of the turbine shroud, a rear end of the turbine shroud extending into an inlet end of the ejector shroud.

15. The fluid turbine of claim 12, further comprising a nacelle body rotationally engaged to the rotor, wherein the nacelle body comprises an inlet, an outlet, and a central channel between the inlet and the outlet, wherein the central channel passes through the central passageway of the turbine rotor hub.

16. A shrouded horizontal axis fluid turbine, comprising:
an impeller comprising a stator and a rotor, the rotor comprising seven rotor blades and a rotor hub, the rotor hub having a sidewall and a central passageway; and
a turbine shroud surrounding the impeller, the turbine shroud having a plurality of mixing lobes formed on a trailing edge thereof;
wherein each rotor blade extends radially from the rotor hub and has a root engaging the sidewall of the rotor hub, a tip, a length extending from the root to the tip, the blade having a varying pitch angle along the length of the blade; and
wherein the fluid turbine has a total-to-total efficiency of at least 94%.

17. The fluid turbine of claim 16, wherein the roots of the rotor blades have a pitch angle of from greater than zero to less than 90 degrees relative to a central longitudinal axis of the rotor hub.

18. The fluid turbine of claim 16, further comprising an ejector shroud downstream of the turbine shroud, a rear end of the turbine shroud extending into an inlet end of the ejector shroud.

19. The fluid turbine of claim 16, wherein the blades have an aspect ratio of from 2 to 30.

20. The fluid turbine of claim 16, wherein the varying pitch angle is determined according to the formula α=Kr, where α is the pitch angle in degrees relative to a longitudinal axis of the rotor hub, K is a constant having a value from 0.1 to 90, and r is the distance from the root.
